(19) United States
(12) Patent Application Publication
(10) Pub. No.: US 2018/0052655 A1
(43) Pub. Date: Feb. 22, 2018

(54) TECHNOLOGICAL PLATFORM FOR INDIVIDUALS WITH A DISABILITY

(71) Applicants: John Edward Hannibal, III, Olmsted Township, OH (US); Edward James Yenni, Bay Village, OH (US); Rhonda Sue Buynak, Garfield Heights, OH (US)

(72) Inventors: John Edward Hannibal, III, Olmsted Township, OH (US); Edward James Yenni, Bay Village, OH (US); Rhonda Sue Buynak, Garfield Heights, OH (US)

(21) Appl. No.: 15/678,255

(22) Filed: Aug. 16, 2017

Related U.S. Application Data
(60) Provisional application No. 62/375,743, filed on Aug. 16, 2016.

(51) Int. Cl. G06F 3/16; H04L 29/08; H04L 29/06; G08B 21/02; G08B 21/18; H04R 1/02

(52) U.S. Cl. CPC G06F 3/165; H04L 67/02; H04L 65/60; H04W 4/008; G08B 21/182; H04R 1/028; G08B 21/02

(57) ABSTRACT

A system includes a plurality of depressible buttons on a first surface of the device, a speaker, and a radio receiver configured to receive a plurality of radio stations. A non-transitory computer readable medium stores a media player and an audio file. A processor is operatively connected to the non-transitory computer readable medium and configured to execute the media player to play the audio file. The system further includes a network interface and a configuration interface that allows a user to configure each of the plurality of depressible buttons to perform a selected function. The selected function for each of the depressible buttons can include any of tuning the radio receiver to one of the plurality of radio stations, instructing the processor to execute the media player to play the audio file, and instructing the network interface to retrieve streaming audio from a prespecified uniform resource link.

### RELATED APPLICATIONS

This application claims priority from U.S. Patent Application Ser. No. 62/375,743, filed 16 Aug. 2016, which is incorporated herein in its entirety.

### TECHNICAL FIELD

This invention relates to communications systems, and more particularly, to a technological platform for individuals with a disability.

### BACKGROUND

Individuals with a disability can require a significant amount of monitoring, which can be difficult for family members or other patient advocates who do not live with the individual. Where the patient is supervised by professional caregivers, a patient advocate must interact verbally with an already overburdened caregiver staff to obtain information as to the activities and welfare of a patient. Where the patient lives alone, monitoring of the individual can be limited to periodically checking in with the patient, which can lead to incomplete or inaccurate information about the individual's well-being and activities. This can complicate decision making for patient advocates, consume the time of caretakers, and reduce the quality of life for the individual, as suboptimal decisions can be made absent complete information.

### SUMMARY OF THE INVENTION

In accordance with an aspect of the present invention, a system includes a plurality of depressible buttons on a first surface of the device, a speaker, and a radio receiver configured to receive a plurality of radio stations. A non-transitory computer readable medium stores a media player and an audio file. A processor is operatively connected to the non-transitory computer readable medium and configured to execute the media player to play the audio file. The system further includes a network interface and a configuration interface that allows a user to configure each of the plurality of depressible buttons to perform a selected function. The selected function for each of the depressible buttons can include any of tuning the radio receiver to one of the plurality of radio stations, instructing the processor to execute the media player to play the audio file, and instructing the network interface to retrieve streaming audio from a prespecified uniform resource link. In accordance with another aspect of the present invention, a system includes a plurality of depressible buttons on a first surface of the device, a speaker, a microphone, and a radio receiver configured to receive a plurality of radio stations. A non-transitory computer readable medium stores a media player and an audio file. A processor is operatively connected to the non-transitory computer readable medium and configured to execute the media player to play the audio file. The system further includes a network interface and a configuration interface that allows a user to configure each of the plurality of depressible buttons to perform a selected function. The selected function for each of the depressible buttons can include any of tuning the radio receiver to one of the plurality of radio stations, instructing the processor to execute the media player to play the audio file, instructing the network interface to retrieve streaming audio from a prespecified uniform resource link, and instructing the microphone to record audio as long as the button is depressed as an audio file and instructing the network interface to transmit the audio file to a prespecified recipient when the button is released.

In accordance with yet another aspect of the present invention, a system includes a plurality of depressible buttons on a first surface of the device, a speaker, a Bluetooth Low Energy receiver that receives input from at least one sensor worn by an individual, and a radio receiver configured to receive a plurality of radio stations. A non-transitory computer readable medium stores a media player and an audio file. A processor is operatively connected to the non-transitory computer readable medium and configured to execute the media player to play the audio file. The system further includes a network interface and a configuration interface that allows a user to configure each of the plurality of depressible buttons to perform a selected function. The selected function for each of the depressible buttons can include any of tuning the radio receiver to one of the plurality of radio stations, instructing the processor to execute the media player to play the audio file, and instructing the network interface to retrieve streaming audio from a prespecified uniform resource link.

### BRIEF DESCRIPTION OF THE DRAWINGS

FIG. 1 illustrates a system for use by individuals with a disability;

FIG. 2 illustrates one example of a technology platform in accordance with an aspect of the present invention;

FIG. 3 illustrates a system incorporating a set of remote sensors, actuators, and a technology platform for individuals with a disability in accordance with an aspect of the present invention; and

FIG. 4 is a schematic block diagram illustrating an exemplary system 200 of hardware components capable of implementing examples of the systems and methods disclosed in FIGS. 1-3.

### DETAILED DESCRIPTION OF THE INVENTION

The inventors have provided a system to improve the daily lives of those with a disability while providing information to patient advocates, caregivers, medical providers, and other stakeholders in patient care. Specifically a radio/MP3 player is customizable to a given patient's tastes and can be connected to various sensors for monitoring the physical condition, living environment, activities, and well-being of the individual. The device has greatly simplified controls, configurable by a caregiver or other user, allowing it to be quickly learned and used even for patients with significant a disability. This provides entertainment to the patient, and can also be used to facilitate contact with family and other caregivers and to provide appropriate audio for music therapy, when prescribed. The device can be be outfitted with various sensors to monitor the health and comfort of the patient for medical personnel and caregivers. Actuators responsive to the sensors can also be included to increase patient comfort by activating audio, vibration, heat, or aromatherapy when it would be helpful in calming an agitated individual or otherwise improving the comfort of the patient.

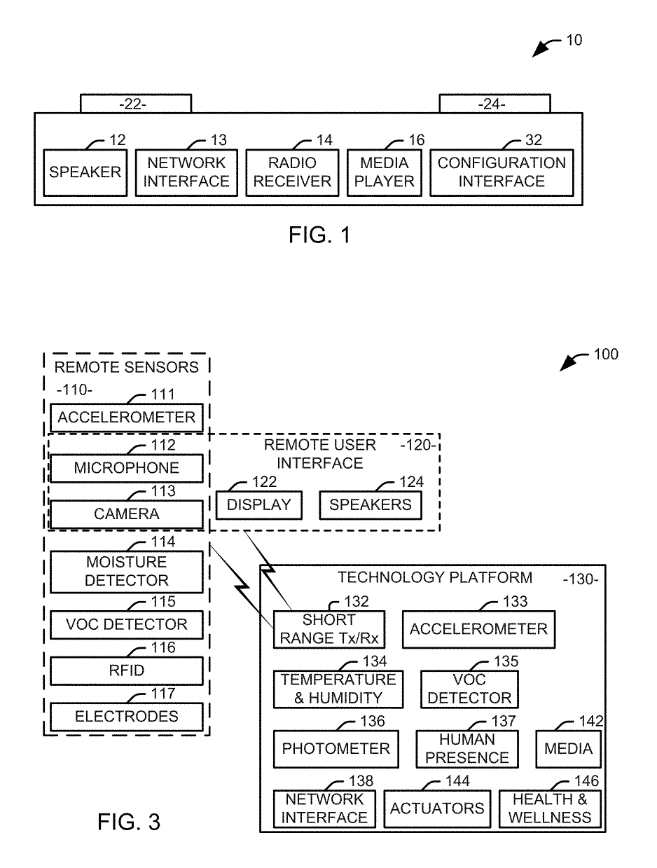

FIG. 1 illustrates a system 10 for use by individuals with a disability. Specifically, the system 10 provides entertainment, generally in the form of music or spoken text, in a form that can be easily accessed without contemporaneous assistance from a caretaker. To this end, the system includes a speaker 12, a network interface 13, a radio receiver 14 configured to receive a plurality of radio stations, and a media player 16, implemented as one or more non-transitory computer readable media that stores instructions for playing audio files and an audio file and a processor, operatively connected to the non-transitory computer readable media, and configured to execute the instructions to play the audio file.

A plurality of depressible buttons 22 and 24 on located a first surface 20 of the device. A configuration interface 32 allows a user to configure each of the plurality of depressible buttons to perform a selected function. The selected function for each of the depressible buttons can include any of tuning the radio receiver to one of the plurality of radio stations, instructing the processor to execute the media player to play the audio file, and instructing the network interface to retrieve streaming audio from a prespecified uniform resource link (URL).

In one implementation, the system includes a short range transceiver, such as a Bluetooth or Bluetooth Low Energy transceiver, that receives input from at least one sensor worn by an individual. The sensors can include one or more of a moisture sensor, a three-axis accelerometer, and a set of electrodes configured to provide an electroencephalograph of the individual. A message can be provided, via the network interface, to a caretaker of the individual in response to input from sensors worn by the individual. The short range transceiver can also be used for communicating with other devices, including third-party devices, worn by the individual, such as headphones, fitness monitors, and similar devices. In another implementation, the system 10 can include a microphone, and the selected function for each of the depressible buttons 22 and 24 can also include instructing the microphone to record audio as long as the button is depressed as an audio file and instructing the network interface 13 to transmit the audio file to a prespecified recipient when the button is released.

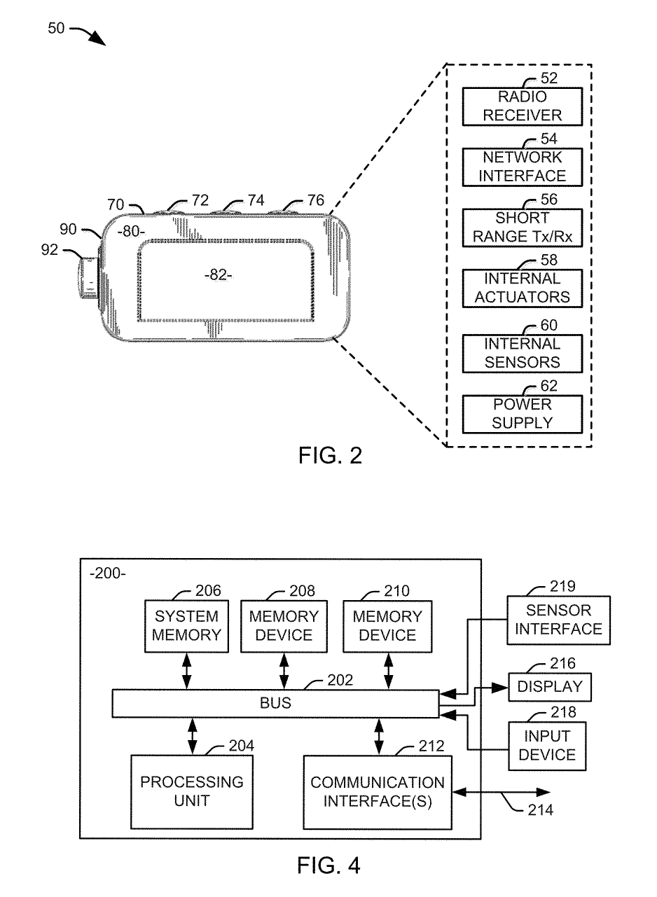

FIG. 2 illustrates another example of a technology platform 50 in accordance with an aspect of the present invention. In the illustrated example, the platform 50 includes a radio receiver 52 capable of receiving audio content, for example, from the amplitude modulated (AM) band, the frequency modulated (FM) band, or one of the S-band and L-band associated with satellite radio. In one implementation, an FM antenna (not shown) can be incorporated into a power cord of the device, and an AM antenna can be integral to the device to maintain a consistent device profile. The platform 50 can also include a network interface 54 configured to provide a wired or wireless Internet connection for the device. The network interface 54 can include, for example, a Wi-Fi transceiver, an Ethernet interface for receiving a wired connection, or a cellular transceiver to provide a cellular data connection (e.g., 4G or LTE). In one implementation, a low-bandwidth communications channel such as category M1 can be used, particularly to send sensor data and allow for remote control for local actuators. It will be appreciated, however, that the technology platform 50 could instead utilize only one of the radio receiver 52 and the network interface 54. For example, audio content could be provided as streaming audio via the network interface.

As is discussed above in detail, the platform 50 can include a short range transceiver (Tx/Rx) 56, such as a Bluetooth and/or a Bluetooth Low Energy transceiver, for communication with remote devices within the room of the patient, as well as a set of internal actuators 58 and internal sensors 60. A power supply 62 can include a power line and appropriate transformer for drawing power from a wall outlet, a disposable or rechargeable battery, or a power line with an internal rechargeable battery as a backup for essential functions of the platform 50. A sleep timer can be included to allow for the device to provide audio only for a specified length of time, with the press of a single button within a set period after the audio ends reactivating the audio. A color display can be provided to show pictures or videos stored on the device, and a clock or calendar can be presented on a display of the device when it is not being used to display media. The entire platform 50 can be provided in colors known to be appealing to individuals with a disability to encourage interaction with the device.

The platform 50 can also include a volume control (not shown) that is designed to be easily manipulated by an individual with a disability and a plurality of configurable input elements 72, 74, and 76 that are sized and positioned to be easily accessible for a user. In one example, each configurable input element 72, 74, and 76 is implemented as a large button on an upper surface 70 of the platform 50 that is configured for a single purpose. In one implementation, one or more of the configurable input elements 72, 74, and 76 can be configured to tune the radio receiver 52 to a predetermined channel or request streaming content from a specific URL via the network interface 54. In another implementation, a given input element (e.g., 72) can be configured to alert a caregiver that the individual requires assistance. In another implementation, a given input element (e.g., 76) can used to send a voice message to a predetermined recipient, with the message content recorded during the period that the input element is activated.

The function of each input element 72, 74, and 76 can be set at a configuration panel (not shown) hidden behind a removable panel 82 on a second surface 80 of the device. Depending on the functions included with the device, the configuration panel can be implemented as a series of dual in-line package (DIP) switches, a series of dials, or a touch screen interface. In one implementation, the configurable panel can be replaced with a remote interface that allows the device settings to be set at a remote computer or mobile device maintained by the caregiver. Along with setting the function for each input element 72, 74, and 76, the configuration panel can be used to configure other parts of the device function, such as setting up wireless networks, selecting destinations for messages to caretakers and others, setting a maximum volume of the device, and selecting a duration of a sleep timer. In one implementation, thresholds and alert types associated with the health and wellness component, discussed below, can also be set through the configuration panel. The device 50 can further include a volume knob 92 extending from a third surface 90 of the device that allows an individual to adjust the volume of audio played from the device. The configuration interface can allow a user or caretaker to set a maximum volume for audio provided from the speaker, regardless of the setting at the volume knob 92.

FIG. 3 illustrates a one example of a system 100 for individuals with a disability. In the illustrated implementation, the system 100 incorporates a set of remote sensors 110, a set of actuators (e.g., 144), and a technology platform 130 for individuals with a disability in accordance with an aspect of the present invention. The set of remote sensors 110 and one or more actuators can be incorporated into garments or other wearable articles worn by an individual with a disability or incorporated into furniture and fixtures within a room occupied by the individual. In one implementation, the set of remote sensors 110 can include a three-axis accelerometer 111, a microphone 112, a camera sensitive within one of the visible and infrared ranges 113, moisture detectors 114, detectors for volatile organic compounds (VOC) 115, proximity sensors, such as radio frequency identification (RFID) devices 116 configured to detect the individual's proximity to various preselected locations within the room, such as the technology platform 130, and medical sensors, such as electrodes 117 configured to collecting electroencephalography (EEG) or electrocardiogram (ECG) data. Each of the sensors can be configured to communicate directly with the technology platform 130 or an intermediary (not shown) capable of direct communication with a short range transceiver 132 associated with the technology platform. In one implementation, the set of remote sensors 110 communicate with the technology platform 130 via a short range data connection such as Bluetooth Low Energy.

In addition to receiving data from the set of remote sensors 110, the short range transceiver 132 can also communicate with one or more user interface (UI) components 120 remote from the device. It will be appreciated that the user interface components 120 can overlap to an extent with the set of remote sensors. For example, a microphone 112 can be utilized both to receive voice commands from the individual as well as monitor the health and wellness of the individual, as discussed further below. A visible or infrared light camera 113 can be used to receive gesture input from the user as well as provide data for the health and wellness monitoring.

Further, the remote user interface components 120 can be used to provide enhanced video or audio to the visually impaired. In one implementation, the remote user interface components 120 can include a display 122, such as a large monitor, touch screen, or set of virtual reality goggles to provide a magnified or otherwise enhanced image of either a field of view in front of the individual, provided via an associated camera 113 worn by the individual, or an entire virtual room, provided from a set of cameras positioned in the room to provide suitable input for a virtual representation. Video content from the technology platform 130 could also be provided through the remote user interface components. Similarly, audio from the technology platform 130 can be provided to speakers 124 worn by the individual or positioned around the room. In one implementation, audio from a microphone 112 worn by the individual can be provided to a remote speaker worn by the individual to amplify speech or audio content in the vicinity of the individual.

The short range transceiver 132 can also communicate with one or more third party devices to provide data concerning the health and wellness of the individual. For example, the short range transceiver 132 can communicate with a wearable fitness monitor (not shown) or a similar device to obtain data on the activity, respiration rate, and heart rate of the individual. Similarly, the technology platform 130 can be configured to communicate with assistance request systems and home automation products via the short range transceiver 132. For example, if it is determined from data received from the set of remote sensors 110 that an individual is in need of assistance, as discussed further below, the technology platform 130 can instruct an assistance request system to alert a caretaker. Similarly, if it is determined that an individual has begun sleeping, the technology platform 130 can instruct a home automation system to dim lighting or mute or reduce the volume of audio content to avoid interfering with the rest of the individual.

The technology platform 130 can further include internal sensors that monitor the individual's wellness and interaction with the platform. For example, the internal sensors can include a three-axis accelerometer 133, temperature and humidity sensors 134, a volatile organic compound (VOC) sensor 135, a photometer 136, and a human presence detector 137 that utilizes any of changes in ambient sound or light, detected infrared light, or radio frequency identification to determine if the individual, a caretaker, or a visitor has been in the proximity of the technological platform. A network interface 138 allows the device to communicate via a wired or wireless internet connection. The technology platform 130 can also include a media component 142 configured to provide one or both of audio or video content to an individual from stored content, the Internet connection, or broadcast content.

The technology platform 130 can further include a set of internal actuators 144 that can facilitate communication with caretakers and others or improve a quality of life of the individual. The internal actuators 144 can include, for example, a warning beacon that indicates that a patient is in need of assistance, a speech synthesizer that can deliver messages concerning patient care based on input from the worn 110 and internal 133-137 sensors, or similar devices to enhance patient care. It will be appreciated that some external actuators (not shown) can be worn by the individual to provide heat, vibration, or aromatherapy to the patient when a need is indicated, or assist in communicating with caretakers. For example, when it is determined at a health and wellness component 146 that an individual is in need of assistance, an audible or visible indicator on the technology platform can be activated to alert a local caregiver and/or a message can be sent to a remote caregiver via the Internet connection. Similarly, a touchscreen or writing surface can be included to allow the individual to communicate with a remote or local caregiver, with a handwritten message sent to a prespecified recipient either upon actuation of a button on the device or the passage of a predetermined period of time after the individual is done interacting with the device. An electronic aroma dispenser 148 can be activated anytime that a threshold value of volatile organic compounds are detected at the internal sensors 133-137 and/or the set of remote sensors 110 to mask any odor represented by the organic compounds or whenever a patient is agitated to provide aromatherapy.

Data from the internal sensors 133-137 and the set of remote sensors 110 can be recorded at the device for review by a physician, nurse, or other caregiver as well as provided to the health and wellness component 146. It will be appreciated that the health and wellness component 146 can be implemented as dedicated hardware, such as an application specific integrated circuit or programmable logic gate, software instructions stored on a non-transitory medium and executed by an associated processor, or a mix of software and dedicated hardware. The health and wellness component 146 monitors data from the set of remote sensors 110 and the set of internal sensors 133-137 to detect potential changes in the well-being of the individual. The health and wellness component 146 can include a variety of functions ranging from relatively simple thresholding of sensor data to more complex expert systems such as decision trees, anomaly detection algorithms, and other classification systems to determine when a situation has arisen that requires the attention of a caregiver. For example, detection of moisture at a remote moisture sensor or a determination that a respiratory rate or heart rate has fallen below a threshold for a predetermined period of time can result in an immediate notification to a caregiver. Similarly, a detection of volatile organic compounds absent motion from the individual in a predetermined period or other indication that the individual has left their bed or chair prior to the detection can result in notification to the caregiver. Additional information can be detected at the sensors, for example, a frequency of bowel movements or flatulence experienced by the individual at the VOC sensor 135, to determine the effects of medication and diet on the patient and allow for adjustments to increase patient comfort.

Anomaly detection can be used generally to detect a deviation of the individual from a normal baseline that could indicate underlying physical or mental health concerns. For biometric parameters, such a deviation can be immediately reported to the caregiver. For other parameters, such as motion, proximity to the device, detection of volatile organic compounds, and similar parameters, rather than prompting an immediate alert, any persistent deviation of the individual from a determined baseline can be reported to one or more caregivers for a determination of the significance of the deviation. Accordingly, the sensor data can be applied to detect both acute and long-term changes in the health and well-being of the individual.

FIG. 4 is a schematic block diagram illustrating an exemplary system 200 of hardware components capable of implementing examples of the systems and methods disclosed in FIGS. 1-3. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, one or more communication interfaces 212 (e.g., a network interface and/or a Bluetooth or other short range transceiver), a communication link 214, a display 216 (e.g., a video screen), an input device 218 (e.g., a keyboard and/or a mouse), and a sensor interface 219. The system bus 202 can be in communication with the processing unit 204 and the system memory 206. The additional memory devices 208 and 210, such as a hard disk drive, server, stand-alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core. The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in formats comprehensible to human beings. Additionally or alternatively, the system 200 can access an external data source or query source through the communication interface 212, which can communicate with the system bus 202 and the communication link 214.

In operation, the system 200 can be used to implement one or more parts of a health and wellness monitoring system in accordance with the present invention. Computer executable logic for implementing the composite applications testing system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A system, comprising:
a plurality of depressible buttons on a first surface of the device;
a speaker;
a radio receiver configured to receive a plurality of radio stations;
a non-transitory computer readable medium that stores a media player and an audio file;
a processor, operatively connected to the non-transitory computer readable medium, and configured to execute the media player to play the audio file;
a network interface; and
a configuration interface that allows a user to configure each of the plurality of depressible buttons to perform a selected function, wherein the selected function for each of the depressible buttons can include any of tuning the radio receiver to one of the plurality of radio stations, instructing the processor to execute the media player to play the audio file, and instructing the network interface to retrieve streaming audio from a prespecified uniform resource link (URL).

2. The system of claim 1, further comprising a microphone, and the selected function for each of the depressible buttons can include any of tuning the radio receiver to one of the plurality of radio stations, instructing the processor to execute the media player to play the audio file, instructing the network interface to retrieve streaming audio from a prespecified uniform resource link (URL), and instructing the microphone to record audio as long as the button is depressed as an audio file and instructing the network interface to transmit the audio file to a prespecified recipient when the button is released.

3. The system of claim 1, wherein the configuration interface is hidden behind a removable panel on a second surface of the device,

4. The system of claim 3, further comprising a volume knob extending from a third surface of the device, the configuration interface allowing a user to set a maximum volume for audio provided from the speaker.

5. The system of claim 1, further comprising a human presence detector that monitors one of ambient sound, ambient light, infrared light, and radio frequency identification to determine if a human being has been in the proximity of the system.

6. The system of claim 1, further comprising a volatile organic compound sensor that detects volatile organic compounds in the air and notifies a caretaker when a threshold level is exceeded.

7. The system of claim 1, further comprising a short range transceiver that receives input from at least one sensor worn by an individual.

8. The system of claim 7, wherein the at least one sensor comprises a moisture sensor.

9. The system of claim 7, wherein the at least one sensor comprises a three-axis accelerometer.

10. The system of claim 7, wherein the at least one sensor comprises a set of electrodes configured to provide an electroencephalograph of the individual.

11. The system of claim 7, wherein a message is provided, via the network interface, to a caretaker of the individual in response to input from the at least one sensor worn by the individual.

12. The system of claim 1, further comprising a radio frequency identification (RFID) sensor, worn by an individual, that indicates when the individual approaches the device.

13. The system of claim 1, wherein the network interface connects the system to the Internet via a Wi-Fi signal.

14. A system, comprising:
a plurality of depressible buttons on a first surface of the device;
a speaker;
a microphone;
a radio receiver configured to receive a plurality of radio stations;
a non-transitory computer readable medium that stores a media player and an audio file;
a processor, operatively connected to the non-transitory computer readable medium, and configured to execute the media player to play the audio file;
a network interface; and
a configuration interface, hidden behind a removable panel on a second surface of the device, that allows a user to configure each of the plurality of depressible buttons to perform a selected function, wherein the selected function for each of the depressible buttons can include any of tuning the radio receiver to one of the plurality of radio stations, instructing the processor to execute the media player to play the audio file, instructing the network interface to retrieve streaming audio from a prespecified uniform resource link (URL), and instructing the microphone to record audio as long as the button is depressed as an audio file and instructing the network interface to transmit the audio file to a prespecified recipient when the button is released.

15. The system of claim 14, further comprising a Bluetooth Low Energy receiver that receives input from at least one sensor worn by an individual.

16. The system of claim 14, wherein the system further comprises an electronic writing surface that receives a handwritten message from an individual and instructs the network interface to provide the handwritten message to a prespecified recipient.

17. A system, comprising:
a plurality of depressible buttons on a first surface of the device;
a speaker;
a Bluetooth Low Energy receiver that receives input from at least one sensor worn by an individual;
a radio receiver configured to receive a plurality of radio stations;
a non-transitory computer readable medium that stores a media player and an audio file;
a processor, operatively connected to the non-transitory computer readable medium, and configured to execute the media player to play the audio file;
a network interface; and
a configuration interface, hidden behind a removable panel on a second surface of the device, that allows a user to configure each of the plurality of depressible buttons to perform a selected function, wherein the selected function for each of the depressible buttons can include any of tuning the radio receiver to one of the plurality of radio stations, instructing the processor to execute the media player to play the audio file, and instructing the network interface to retrieve streaming audio from a prespecified uniform resource link (URL).

18. The system of claim 17, further comprising a microphone, and the selected function for each of the depressible buttons can include any of tuning the radio receiver to one of the plurality of radio stations, instructing the processor to execute the media player to play the audio file, instructing the network interface to retrieve streaming audio from a prespecified uniform resource link (URL), and instructing the microphone to record audio as long as the button is depressed as an audio file and instructing the network interface to transmit the audio file to a prespecified recipient when the button is released.

19. The system of claim 17, wherein a message is provided, via the network interface, to a caretaker of the individual in response to input from the at least one sensor worn by the individual.

20. The system of claim 17, further comprising a human presence detector that monitors one of ambient sound, ambient light, infrared light, and radio frequency identification to determine if a human being has been in the proximity of the system.
